(19) United States
(12) Patent Application Publication
(10) Pub. No.: US 2024/0147203 A1
(43) Pub. Date: May 2, 2024

(54) SERVER, COMMUNICATION SYSTEM, AND METHOD

(71) Applicant: NEC Corporation, Minato-ku, Tokyo (JP)

(72) Inventors: Kosei KOBAYASHI, Tokyo (JP); Tetsuji KAWATSU, Tokyo (JP); Kazuki OGATA, Tokyo (JP); Yuji SATO, Tokyo (JP); Tetsuya TAKAKI, Tokyo (JP); Jun TAKASAWA, Tokyo (JP); Hiroaki AMINAKA, Tokyo (JP); Kei YANAGISAWA, Tokyo (JP)

(73) Assignee: NEC Corporation, Minato-ku, Tokyo (JP)

(21) Appl. No.: 18/278,743

(22) PCT Filed: Mar. 31, 2021
(86) PCT No.: PCT/JP2021/013803

§ 371 Date: Aug. 24, 2023

(51) Int. Cl. H04W 4/46; H04W 64/00

(52) U.S. Cl. CPC H04W 4/46; H04W 64/00

(57) ABSTRACT

In one aspect, a reception means receives, from a roadside device, first information transmitted from a mobile body by using a first wireless communication. An identification means identifies, based on information of a terminal apparatus to be managed by an information management means, the terminal apparatus being located in the vicinity of the mobile body that has transmitted the first information. A transmission means transmits second information generated based on the first information, to the terminal apparatus identified by the identification means via a second wireless communication.

### TECHNICAL FIELD

The present disclosure relates to a server, a communication system, a method, and a computer-readable medium.

### BACKGROUND ART

As a means for achieving safe and efficient traffic, vehicle-to-vehicle communication and road-to-vehicle communication are becoming popular as development of technologies for vehicle driving support and self-driving progresses. However, during a transitional period, not all vehicles are equipped with an in-vehicle apparatus having a Vehicle to Vehicle (V2V) communication function. In order to achieve safe and efficient traffic, information notice from a vehicle having a V2V communication function (hereinafter referred to as a V2V-mounted vehicle) to a vehicle having no V2V communication function (hereinafter referred to as a V2V-non-mounted vehicle) and information notice from a V2V-non-mounted vehicle to a V2V-mounted vehicle are required.

As a related art, Patent Literature 1 constructs a communication system that performs road-to-vehicle communication. In Patent Literature 1, an infrastructure such as a traffic light or a road sign includes a first communication apparatus, a data processing apparatus, and a second communication apparatus. The first communication apparatus performs communication of a broadcast scheme, such as Vehicle to Everything (V2X) communication, with a vehicle (in-vehicle communication apparatus). The second communication apparatus performs communication of a unicast or multicast scheme with a mobile terminal of a pedestrian. The second communication apparatus is configured as a Wi-Fi (registered trademark) communication apparatus or a Bluetooth (registered trademark) communication apparatus.

In Patent Literature 1, the data processing apparatus of the infrastructure acquires position information of a pedestrian via the second communication apparatus. The data processing apparatus generates map information (LDM: Local Dynamic Map) in which position information of a plurality of pedestrians is integrated. The data processing apparatus transmits the generated map information to the in-vehicle communication apparatus through the V2X communication.

Further, in Patent Literature 1, the first communication apparatus of the infrastructure receives a signal for sending that an emergency vehicle is approaching, from an in-vehicle communication apparatus of the emergency vehicle. The first communication apparatus transmits attention calling information indicating that an emergency vehicle passes, to an in-vehicle communication apparatus of a general vehicle. Further, the data processing apparatus transmits, via the second communication apparatus, to the mobile terminal of the pedestrian, the attention calling information indicating that the emergency vehicle passes.

### CITATION LIST

### Patent Literature

[Patent Literature 1] Japanese Unexamined Patent Application Publication No. 2017-068335

### SUMMARY OF INVENTION

### Technical Problem

The infrastructure described in Patent Literature 1 can transmit position information received from a mobile terminal of a pedestrian, to a vehicle surrounding the infrastructure through V2X communication being broadcast communication. In addition, when receiving a signal from an emergency vehicle through V2X communication, the infrastructure can transmit attention calling information to a mobile terminal of a pedestrian surrounding the infrastructure.

However, in Patent Literature 1, the second communication apparatus of the infrastructure can only communicate with a mobile terminal existing within a communicable range of the own apparatus. Therefore, even in a case where there is a pedestrian immediately close to the vehicle, when the pedestrian is located at a place away from a place where the second communication apparatus is installed (for example, an intersection), the second communication apparatus may not receive position information from the mobile terminal of the pedestrian and may not send a position of the pedestrian to the vehicle. Further, even in a case where a pedestrian is located at a place where the V2X communication from the emergency vehicle can be received, when the pedestrian is outside the communicable range of the second communication apparatus, a mobile terminal of the pedestrian cannot receive attention calling information.

In view of the above-mentioned circumstances, an object of the present disclosure is to provide a server, a communication system, a method, and a computer-readable medium that are capable of transmitting and receiving information between a plurality of apparatuses using different communication schemes.

### Solution to Problem

In order to achieve the above-mentioned object, the present disclosure provides a server as a first aspect. The server according to the first aspect includes: a reception means for receiving, from a roadside device, first information transmitted from a mobile body by using a first wireless communication; an information management means for managing information of a terminal apparatus having a function of performing a second wireless communication; an identification means for identifying the terminal apparatus being located around the mobile body that has transmitted the first information, based on information of the terminal apparatus to be managed by the information management means; and a transmission means for transmitting, to the terminal apparatus identified by the identification means, second information generated based on the first information, via the second wireless communication.

The present disclosure provides, as a second aspect, a server. The server according to the second aspect includes: a reception means for receiving first information from a terminal apparatus having a function of performing a first wireless communication via the first wireless communication; an information management means for managing information of a roadside device that communicates with a mobile body by using a second wireless communication; an identification means for identifying the roadside device being located around the terminal apparatus that has transmitted the first information, based on information of the roadside device to be managed by the information management means; and a transmission means for transmitting second information generated based on the first information to the roadside device identified by the identification means, and causing the roadside device to transmit the second information to the mobile body by using the second wireless communication.

The present disclosure provides, as a third aspect, a communication system. The communication system according to the third aspect includes a roadside device configured to communicate with a mobile body by using a first wireless communication, and a server. The roadside device includes a reception means for receiving first information transmitted from the mobile body by using the first wireless communication, and a transmission means for transmitting the received first information to the server. The server includes: a reception means for receiving the first information from the roadside device; an information management means for managing information of a terminal apparatus having a function of performing a second wireless communication; an identification means for identifying the terminal apparatus being located around the mobile body that has transmitted the first information, based on information of the terminal apparatus to be managed by the information management means; and a transmission means for transmitting, to the terminal apparatus identified by the identification means, second information generated based on the first information, via the second wireless communication.

The present disclosure provides, as a fourth aspect, a communication system. The communication system according to the fourth aspect includes a server configured to communicate with a terminal apparatus by using a first wireless communication, and a roadside device configured to communicate with a mobile body by using a second wireless communication. The server includes: a reception means for receiving first information from the terminal apparatus via the first wireless communication; an information management means for managing information of the roadside device; an identification means for identifying the roadside device being located around the terminal apparatus that has transmitted the first information, based on the information of the roadside device to be managed by the information management means; and a transmission means for transmitting second information generated based on the first information to the roadside device identified by the identification means. The roadside device includes a reception means for receiving the second information from the server, and a transmission means for transmitting the received second information to the mobile body by using the second wireless communication.

The present disclosure provides, as a fifth aspect, a communication method. The communication method according to the fifth aspect includes: receiving, from a roadside device, first information transmitted from a mobile body by using a first wireless communication; identifying, based on information of a terminal apparatus having a function of performing a second wireless communication, the terminal apparatus being located around the mobile body that has transmitted the first information; and transmitting, to the identified terminal apparatus, second information generated based on the first information, via the second wireless communication.

The present disclosure provides, as a sixth aspect, a communication method. The communication method according to the sixth aspect includes: receiving first information from a terminal apparatus having a function of performing a first wireless communication, via the first wireless communication; identifying, based on information of a roadside device configured to communicate with a mobile body by using a second wireless communication, the roadside device being located around the terminal apparatus that has transmitted the first information; transmitting second information generated based on the first information to the identified roadside device; and causing the roadside device to transmit the second information to the mobile body by using the second wireless communication.

The present disclosure provides, as a seventh aspect, a computer-readable medium. The computer-readable medium stores a program for causing a computer to execute processing of: receiving, from a roadside device, first information transmitted from a mobile body by using a first wireless communication; identifying, based on information of a terminal apparatus having a function of performing a second wireless communication, the terminal apparatus being located around the mobile body that has transmitted the first information; and transmitting, to the identified terminal apparatus, second information generated based on the first information via the second wireless communication.

The present disclosure provides, as an eighth aspect, a computer-readable medium. The computer-readable medium according to the eighth aspect stores a program for causing a computer to execute processing of: receiving first information from a terminal apparatus having a function of performing a first wireless communication, via the first wireless communication; identifying, based on information of a roadside device configured to communicate with a mobile body by using a second wireless communication, the roadside device being located around the terminal apparatus that has transmitted the first information; transmitting, to the identified roadside device, second information generated based on the first information; and causing the roadside device to transmit the second information to the mobile body by using the second wireless communication.

### Advantageous Effects of Invention

The server, the communication system, the method, and the computer-readable medium according to the present disclosure are able to transmit and receive information between a plurality of apparatuses using different communication schemes.

### BRIEF DESCRIPTION OF DRAWINGS

FIG. 1 is a block diagram illustrating a schematic configuration of a communication system according to the present disclosure;

FIG. 2 is a block diagram illustrating a schematic configuration example of a roadside device in a communication system according to the present disclosure;

FIG. 3 is a block diagram illustrating a schematic configuration example of a server according to the present disclosure;

FIG. 4 is a block diagram illustrating a communication system according to a first example embodiment of the present disclosure;

FIG. 5 is a block diagram illustrating a configuration example of a MEC server;

FIG. 6 is a flow chart illustrating an operation procedure of the MEC server according to the first example embodiment;

FIG. 7 is a block diagram illustrating a communication system in a different aspect from FIG. 4;

FIG. 8 is a block diagram illustrating a communication system according to a second example embodiment of the present disclosure;

FIG. 9 is a flow chart illustrating an operation procedure of a MEC server according to the second example embodiment; and

FIG. 10 is a block diagram illustrating a configuration example of a computer apparatus.

### EXAMPLE EMBODIMENT

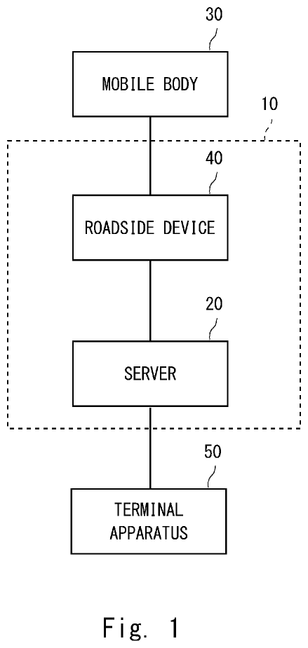

Prior to explanation of the example embodiments of the present disclosure, an outline of the present disclosure will be explained. FIG. 1 illustrates a schematic configuration of a communication system according to the present disclosure. A communication system 10 includes a server 20 and a roadside device 40. The roadside device 40 communicates with a mobile body 30 by using a predetermined wireless communication. The server 20 communicates with a terminal apparatus 50 via a wireless communication different from a communication scheme used in the roadside device 40.

The server 20 receives first information transmitted from the mobile body or first information transmitted from the terminal apparatus 50. When the first information is transmitted from the mobile body 30, the server 20 transmits second information based on the first information to the terminal apparatus 50. When the terminal apparatus 50 transmits the first information, the server 20 transmits the second information based on the first information to the roadside device 40, and causes the roadside device 40 to transmit the second information to the mobile body 30.

In the following explanation, when the first information is transmitted from the mobile body 30, the wireless communication used in the communication between the mobile body 30 and the roadside device 40 is referred to as a first wireless communication. Further, the wireless communication used in the communication between the server 20 and the terminal apparatus 50 is referred to as a second wireless communication. When the first information is transmitted from the terminal apparatus 50, the wireless communication used in the communication between the server 20 and the terminal apparatus 50 is referred to as a first wireless communication. Further, the wireless communication used in the communication between the mobile body 30 and the roadside device 40 is referred to as a second wireless communication.

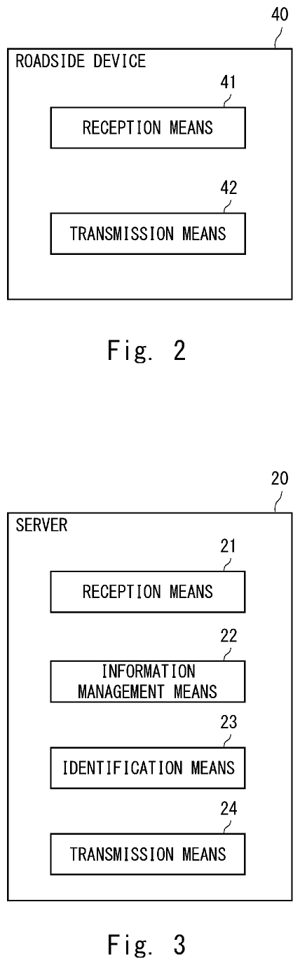

FIG. 2 illustrates a schematic configuration example of the roadside device. The roadside device 40 includes a reception means 41 and a transmission means 42. When the first information is transmitted from the mobile body 30, the reception means 41 receives the first information from the mobile body 30 by using the first wireless communication. When the first information is received from the mobile body 30, the transmission means 42 transmits the first information to the server 20.

When the first information is transmitted from the terminal apparatus 50, the reception means 41 receives second information generated based on the first information from the server 20. The transmission means 42 transmits the second information received from the server 20 to the mobile body 30 by using the second wireless communication.

FIG. 3 illustrates a schematic configuration example of the server. The server 20 includes a reception means 21, an information management means 22, an identification means 23, and a transmission means 24. Hereinafter, an operation (a function) of each unit of the server 20 will be explained separately in a case where the first information is transmitted from the mobile body 30 and in a case where the first information is transmitted from the terminal apparatus 50.

First, the operation of each unit of the server 20 when the first information is transmitted from the mobile body 30 will be explained. The roadside device receives the first information transmitted from the mobile body 30 by using the first wireless communication, and transmits the received first information to the server 20. The reception means 21 receives the first information from the roadside device 40. The information management means 22 manages information of the terminal apparatus 50. The identification means 23 identifies the terminal apparatus 50 located in the vicinity of the mobile body 30 that has transmitted the first information, based on the information of the terminal apparatus 50 to be managed by the information management means 22. The transmission means 24 transmits the second information generated based on the first information to the terminal apparatus 50 identified by the identification means 23 by using the second wireless communication.

In the present disclosure, when the first information is transmitted from the mobile body 30, the server 20 (the identification means 23) identifies the terminal apparatus 50 located in the vicinity of the mobile body 30 that has transmitted the first information, by using the information of the terminal apparatus 50 to be managed by the information management means 22. The transmission means 24 transmits the second information to the identified terminal apparatus 50 located in the vicinity of the mobile body 30. In this case, the server 20 can transmit the second information to the terminal apparatus 50 that is considered to have been able to receive the first information from the mobile body when it is assumed that the terminal apparatus 50 is an apparatus that supports the first wireless communication. As described above, the communication system 10 according to the present disclosure can transmit and receive information between the mobile body 30 and the terminal apparatus 50 having mutually different communication schemes.

The first wireless communication may be a broadcast scheme wireless communication performed between one or more mobile bodies 30 and one or more roadside devices 40. The first wireless communication may be a direct communication in which the mobile bodies 30, and the mobile body 30 and the roadside device 40 can directly communicate with each other without using a relay apparatus such as a base station, among the broadcast scheme wireless communications. The second wireless communication may be a unicast scheme wireless communication. The second wireless communication may be an indirect communication in which communication is performed via a relay apparatus such as a base station, among the unicast scheme wireless communications.

Next, the operation of each unit of the server 20 when the first information is transmitted from the terminal apparatus 50 will be explained. The reception means 21 receives the first information transmitted from the terminal apparatus 50 by using the first wireless communication. The information management means 22 manages information of the roadside device 40. The identification means 23 identifies the roadside device 40 located in the vicinity of the terminal apparatus 50 that has transmitted the first information, based on the information of the roadside device 40 to be managed by the information management means 22. The transmission means 24 transmits the second information generated based on the first information to the roadside device 40 identified by the identification means 23, and causes the roadside device 40 to transmit the second information to the mobile body 30 by using the second wireless communication.

In the present disclosure, when the terminal apparatus 50 transmits the first information, the server 20 (identification means 23) uses the information of the roadside device 40 to be managed by the information management means 22, and identifies the roadside device 40 located in the vicinity of the mobile body 30 that has transmitted the first information. The transmission means 24 transmits the second information to the identified roadside device 40 located in the vicinity of the terminal apparatus 50, and causes the roadside device 40 to transmit the second information to the mobile body 30. In this case, the server 20 can transmit the second information to the mobile body 30 that is considered to have been able to receive the first information when it is assumed that the terminal apparatus 50 is an apparatus that supports the second wireless communication. As described above, the communication system 10 according to the present disclosure can transmit and receive information between the mobile body 30 and the terminal apparatus 50 having mutually different communication schemes.

The first wireless communication may be a unicast scheme wireless communication. The first wireless communication may be an indirect communication in which communication is performed via a relay apparatus such as a base station, among the unicast scheme wireless communications. The second wireless communication may be a broadcast scheme wireless communication performed between the one or more mobile bodies 30 and the one or more roadside devices 40. The second wireless communication may be a direct communication in which the mobile bodies 30, and the mobile body 30 and the roadside device 40 can directly communicate with each other without using a relay device such as a base station, among the broadcast scheme wireless communications.

Hereinafter, example embodiments of the present disclosure will be explained in detail. Note that the following description and the drawings are omitted and simplified as appropriate for clarity of explanation. In the following drawings, the same or associated elements are denoted by the same reference numerals, and redundant explanations are omitted as necessary.

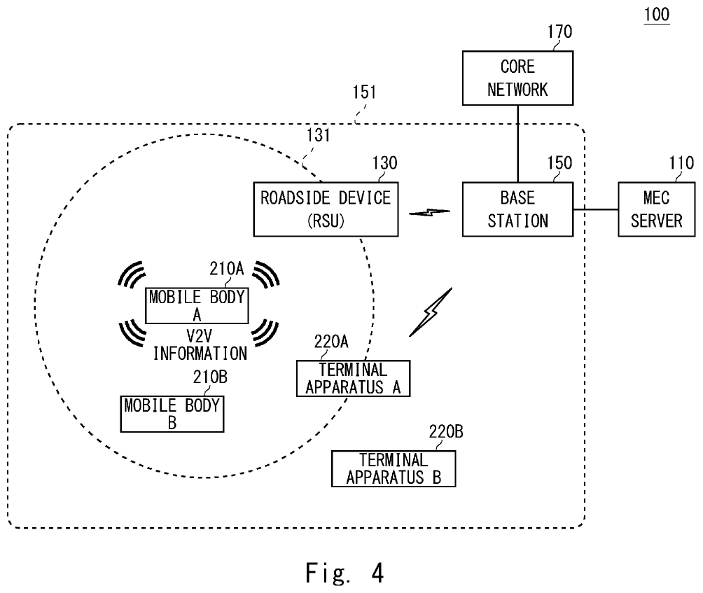

FIG. 4 illustrates a communication system according to a first example embodiment of the present disclosure. A communication system 100 includes a Mobile/Multi-access Edge Computing (MEC) server 110, a roadside device (RSU: Roadside Unit) 130, and a base station 150. The communication system 100 is associated to the communication system 10 illustrated in FIG. 1. The MEC server 110 is associated to the server 20 illustrated in FIG. 1. The roadside device 130 is associated to the roadside device 40 illustrated in FIG. 1. The present example embodiment is an example embodiment in which V2V information transmitted from a mobile body is transmitted to a terminal apparatus.

The roadside device 130 is a wireless communication apparatus that performs wireless communication with a mobile body 210A (mobile body A) and a mobile body 210B (mobile body B). The roadside device 130 may be installed in a roadside facility such as, for example, a traffic light. In the following description, the mobile bodies 210A and 210B are also collectively referred to as a mobile body 210, when no particular distinction is necessary. The mobile body 210 is associated to the mobile body 30 illustrated in FIG. 1.

Each of the mobile body 210 and the roadside device 130 is equipped with a communication apparatus capable of performing wireless communication with each other. The mobile body 210 is configured as a land vehicle such as, for example, a car, a bus, a taxi, a truck, an Automatic Guided Vehicle (AGV), or an Autonomous Mobile Robot (AMV). In addition, the mobile body 210 may be configured as an aircraft such as a drone.

The broadcast scheme wireless communication (first wireless communication) is conducted between the roadside device 130, the mobile body 210A, and the mobile body 210B. For example, the mobile bodies 210 can broadcast V2V information by using a PC5 direct communication, which is one of wireless communication interfaces in Long Term Evolution (LTE) and 5th generation (5G) communication standards, as the first wireless communication. As another example, the mobile bodies 210 may broadcast V2V information by using Dedicated Short Range Communications (DSRC) communication. In FIG. 4, a radio wave mark represented by three lines represents the first wireless communication. When the mobile body 210A broadcasts the V2V information, another mobile body 210 and the roadside device 130 that exist in a communicable range 131 of the mobile body 210A can receive the V2V information. For example, in FIG. 4, each of the roadside device 130 and the mobile body 210B receives V2V information broadcast from the mobile body 210A. A communication between the roadside device 130 and the mobile body 210 is also referred to as V2V communication or Vehicle to Infrastructure (V2I) communication.

The base station 150 performs wireless communication (second wireless communication) with each of a terminal apparatus 220A (terminal apparatus A), a terminal apparatus 220B (terminal apparatus B), and the roadside device 130 that exist within a communicable range 151 of the own station. In FIG. 4, a lightning mark represents a second wireless communication. The base station 150 may be a base station in a wireless communication network using a communication standard such as LTE, LTE-Advanced, or 5G. The base station 150 is connected to a core network 170. The core network 170 is also referred to as an Evolved Packet Core (EPC) in the case of LTE or LTE-Advanced, and a 5th Generation Core network (5GC) in the case of 5G.

The second wireless communication may be a Uu communication, for example, when being based on LTE, LTE-Advanced, 5G communication standards. The MEC server 110, the terminal apparatus 220A, the terminal apparatus 220B, and the roadside device 130 conduct a unicast scheme communication via the Uu communication by the base station 150. The Uu communication is an indirect communication scheme in which communication is performed via the base station 150. The roadside device 130 does not necessarily need to be connected to the MEC server 110 via the base station 150 (via Uu communication). The roadside device 130 may be connected to the MEC server 110 by any means, such as a wired line or a wireless line, without using the base station 150.

Each of the terminal apparatuses 220A and 220B is configured as, for example, a terminal apparatus having a communication function by the second wireless communication carried by a person getting on the vehicle. The terminal apparatuses 220A and 220B may be configured as apparatuses to be attached to a vehicle. In the following description, the terminal apparatuses 220A and 220B are also collectively referred to as a terminal apparatus 220 in a case where distinction is not particularly necessary. The terminal apparatus 220 is associated to the terminal apparatus 50 illustrated in FIG. 1. Examples of the terminal apparatus 220 include apparatuses such as a smart phone, a tablet, and a notebook Personal Computer (PC). Examples of the terminal apparatus 220 may also include an apparatus such as car navigation. In the following explanation, it is assumed that the terminal apparatus 220 does not support the communication function by the first wireless communication. In the following explanation, it is assumed that the terminal apparatus 220 does not support the communication function by the first wireless communication. Namely, it is assumed that the terminal apparatus 220 cannot receive, by using the first wireless communication, the V2V information transmitted from the mobile body 210 by using the first wireless communication.

Although one MEC server 110, one roadside device 130, and one base station 150 are illustrated in FIG. 4, the number of the MEC server 110, the roadside device 130, and the base station 150 in the communication system 100 is not particularly limited. The communication system 100 may include a plurality of MEC servers 110. The communication system 100 may include a plurality of roadside devices 130. The communication system 100 may also include a plurality of base stations 150.

In the present example embodiment, the server is configured as a MEC server 110 arranged in association with the base station 150. The MEC server 110 may not necessarily be configured as a server associated with the base station 150. For example, the MEC server 110 may be installed not in unit of a base station but in unit of a predetermined area. Alternatively, it may be installed in association with the roadside device 130. Alternatively, the MEC server 110 (the function thereof) may be achieved as the roadside device 130 (the function thereof). Further, in the communication system 100, a server (a server on the cloud) connected to the core network 170 may be used instead of the MEC server 110.

When receiving the V2V information (first information) from the mobile body 210, the roadside device 130 transmits the received first information to the MEC server 110. Herein, the first information transmitted from the roadside device 130 to the MEC server 110 may not be strictly the same as the V2V information received from the mobile body 210. The first information transmitted from the roadside device 130 to the MEC server 110 may be information processed in such a way that the V2V information is compatible with the processing in the terminal apparatus 220. The MEC server 110 (server) receives the V2V information from the roadside device 130. The MEC server 110 identifies the terminal apparatus 220 located in the vicinity of the mobile body 210 that has transmitted the V2V information. “The vicinity of the mobile body” means, for example, a range within a predetermined distance from the mobile body 210. The MEC server 110 transmits the second information based on the V2V information to the terminal apparatus 220 identified via the base station 150. In the present example embodiment, the second information may be the same information as the V2V information transmitted from the mobile body 210, or may be information including a part of the V2V information. Further, the second information may be information processed in such a way that the V2V information is compatible with the processing in the terminal apparatus 220. The information processed in such a way that the V2V information is compatible with the processing in the terminal apparatus 220 may be generated by either the MEC server 110 or the roadside device 130. The second information transmitted from the MEC server 110 to the terminal apparatus 220 may be the same information as the information received from the roadside device 130 by the MEC server 110.

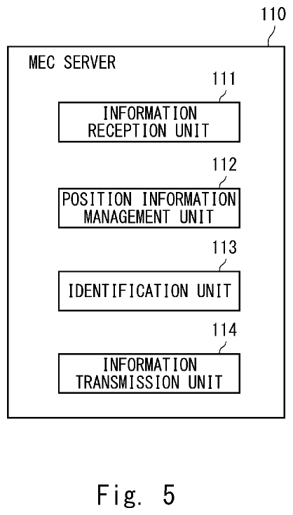

FIG. 5 illustrates a configuration example of the MEC server 110. The MEC server 110 includes an information reception unit 111, a position information management unit 112, an identification unit 113, and an information transmission unit 114. The MEC server 110 is configured as, for example, a computer apparatus (server apparatus) having a processor and a memory. At least a part of functions of the units of the MEC server 110 may be achieved by the processor operating in accordance with a program read from the memory.

The information reception unit 111 receives, from the roadside device 130, the V2V information received by the roadside device 130 from the mobile body 210. The position information management unit 112 manages information of the terminal apparatus 220. The information of the terminal apparatus 220 includes, for example, position information of the terminal apparatus 220 and communication address information thereof. For example, the position information management unit 112 can acquire the position information and the communication address information of the terminal apparatus 220 from an application mounted on the terminal apparatus 220 periodically or by using a predetermined event as a trigger. Herein, the predetermined event may be at least one of an arrival of a predetermined time, a movement of a predetermined distance or more, a change (handover) of a base station or a cell to be connected, a change of a communication address, and a request from the position information management unit 112. Alternatively, the position information management unit 112 may acquire the position information and the communication address information of the terminal apparatus 220 from another apparatus that manages the position information and the communication address information of the terminal apparatus 220. The another apparatus may be, for example, a LTE or 5G core network apparatus. Specifically, the position information and the communication address information of the terminal apparatus 220 may be acquired from a network apparatus or a network function that is responsible for managing subscriber information and mobility management, such as Home Subscriber Server (HSS) and Mobility Management Entity (MME) in LTE, and Unified Data Management (UDM) and Access and Mobility Management Function (AMF) in 5G. Alternatively, the position information and the communication address information of the terminal apparatus 220 may be acquired via Network Exposure Function (NEF), which is responsible for a function of disclosing functions and information in a 5G system to the outside of the 5G system. The information reception unit 111 is associated to the reception means 21 illustrated in FIG. 3. The position information management unit 112 is associated to the information management means 22 illustrated in FIG. 3.

The identification unit 113 identifies a terminal apparatus located in the vicinity of the mobile body 210 that has transmitted the V2V information, based on the information of the terminal apparatus 220 to be managed by the position information management unit 112. For example, the identification unit 113 identifies one or a plurality of terminal apparatuses 220 existing within a predetermined range from the mobile body 210 that has transmitted the V2V information as terminal apparatuses located in the vicinity of the mobile body 210. Herein, the predetermined range may be, for example, a range within a predetermined distance based on the position of the mobile body 210 that has transmitted the V2V information. Alternatively, the predetermined range may be a range in which the broadcast V2V information can be received (a communicable range of a V2V communication) with the mobile body 210 that has transmitted the V2V information as a base point. For example, the identification unit 113 may set a range within a predetermined distance based on the position of the mobile body 210 as a communicable range of the V2V communication. Alternatively, the identification unit 113 may use a radio wave propagation analysis method such as a ray tracing method, and may acquire a range in which radio waves radiated from the position of the mobile body 210 can be received at a predetermined received power or more, and may use the acquired range as a communicable range of the V2V communication. Alternatively, the identification unit 113 may measure a received power distribution in a case where each point is a radio wave transmission point in advance, and acquire the communicable range of the V2V communication by using the measurement result. In this case, the identification unit 113 may use the measurement result at the radio wave transmission point closest to the position of the mobile body 210. Alternatively, the identification unit 113 may utilize map information including information such as a terrain, a feature, and a road, and discriminate a location in Line of Sight (LOS) and a location in Non Line of Sight (NLOS) from the position of the mobile body 210. The identification unit 113 may acquire the communicable range of the V2V communication by using the discrimination result. In any of the above methods, the identification unit 113 may further consider an antenna height and transmission power of the mobile body 210 used for the V2V communication. Note that the position of the mobile body 210 that has transmitted the V2V information may be determined based on, for example, a camera installed in a traffic light or the like or a video of a surveillance camera capable of capturing a road. Alternatively, the position of the mobile body 210 that has transmitted the V2V information may be determined from the position information included in the transmitted V2V information. Alternatively, the identification unit 113 may use position information of the roadside device 130 that has received the V2V information in place of the position of the mobile body 210 itself that has transmitted the V2V information. In other words, the identification unit 113 may approximately acquire the position of the mobile body 210 that has transmitted the V2V information by using the position information of the roadside device 130 that has received the V2V information. The identification unit 113 is associated to the identification means 23 illustrated in FIG. 3.

The information transmission unit 114 transmits the second information generated based on the V2V information (first information) to the terminal apparatus 220 identified by the identification unit 113. The information transmission unit 114 acquires the communication address information of the identified terminal apparatus 220 from the position information management unit 112, and transmits the second information to the identified terminal apparatus 220 by using the acquired communication address information. The information transmission unit 114 is associated to the transmission means 24 illustrated in FIG. 3.

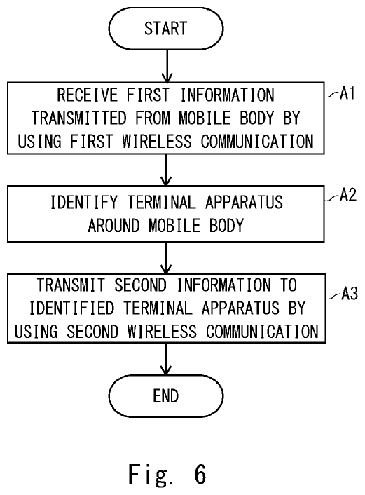

Next, an operation procedure will be explained. FIG. 6 illustrates an operation procedure (communication method) in the MEC server 110. When the mobile body 210 broadcasts the V2V information, the roadside device 130 receives the V2V information transmitted from the mobile body 210 by using the V2V communication (first wireless communication), and transmits the received V2V information to the MEC server 110. The information reception unit 111 of the MEC server 110 receives the V2V information (first information) transmitted from the mobile body 210, from the roadside device 130 (step A1). The identification unit 113 uses the position information of the terminal apparatus 220 to be managed by the position information management unit 112, thereby identifying the terminal apparatus 220 located in the vicinity of the mobile body 210 that has transmitted the V2V information (step A2). The information transmission unit 114 transmits the second information generated based on the V2V information received in step A1 to the terminal apparatus 220 identified in step A2 via the base station 150 via the second wireless communication (Uu communication) (step A3).

For example, in FIG. 4, the mobile body 210A broadcasts the V2V information. The mobile body 210B and the roadside device 130 existing in the communicable range 131 of the mobile body 210A receive the V2V information broadcast from the mobile body 210A. The roadside device 130 transmits the V2V information received from the mobile body 210A to the MEC server 110. Note that, in FIG. 4, the terminal apparatus 220A is a terminal that exists within the communicable range 131 of the mobile body 210A but does not support the V2V communication, and therefore cannot receive the V2V information broadcast from the mobile body 210A.

In the MEC server 110, the information reception unit 111 receives the V2V information transmitted from the mobile body 210, from the roadside device 130. The identification unit 113 identifies a terminal apparatus located in the vicinity of the mobile body 210A, based on the position information of the terminal apparatus 220 to be managed by the position information management unit 112. For example, the identification unit 113 identifies the terminal apparatus 220A existing within the communicable range 131 of the mobile body 210A as a terminal apparatus existing in the vicinity of the mobile body 210A. The information transmission unit 114 transmits the V2V information received from the roadside device 130 to the terminal apparatus 220A by using the Uu communication of the base station 150.

In the present example embodiment, the terminal apparatus 220 located surrounding the mobile body 210 that has transmitted the V2V information is identified, and information generated based on the V2V information is transmitted to the identified terminal apparatus 220. In the example of FIG. 4, the terminal apparatus 220B exists within the communicable range 151 of the base station 150, but exists outside the communicable range 131 of the mobile body 210A. Therefore, the identification unit 113 does not identify the terminal apparatus 220B as the terminal apparatus located in the vicinity of the mobile body 210A. In this case, the information transmission unit 114 does not transmit the information generated based on the V2V information to the terminal apparatus 220B. Therefore, the present example embodiment can suppress information transmission to the terminal apparatus 220 existing at a position away from the mobile body 210.

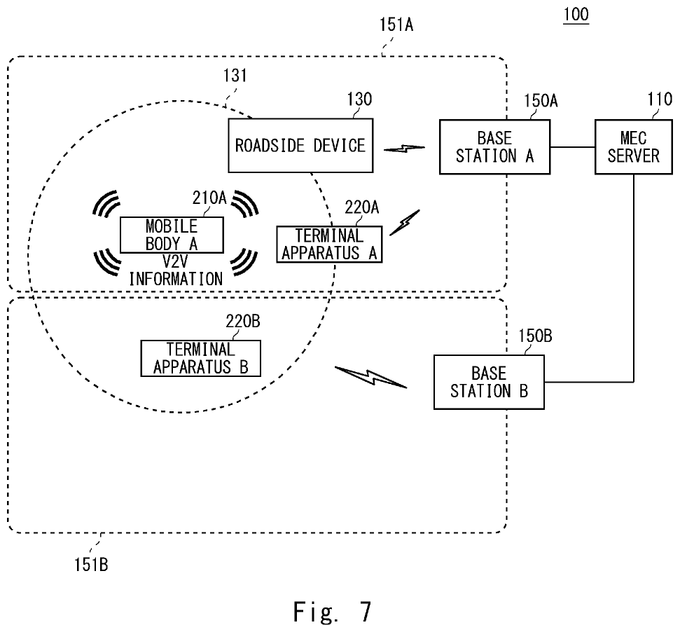

FIG. 7 illustrates a communication system in a different aspect from FIG. 4. In FIG. 7, the communicable range 131 of the mobile body 210A straddles a communicable range 151A of a base station 150A (base station A) and a communicable range 151B of a base station 150B (base station B). In addition, in FIG. 7, the terminal apparatus 220A exists within the communicable range 131 of the mobile body 210A and within the communicable range 151A of the base station 150A. In addition, the terminal apparatus 220B exists within the communicable range 131 of the mobile body 210A and within the communicable range 151B of the base station 150B. In FIG. 7, the core network 170 (see FIG. 4) is not illustrated.

In the above case, the identification unit 113 of the MEC server 110 identifies the terminal apparatus 220A and the terminal apparatus 220B as terminal apparatuses located in the vicinity of the mobile body 210A that has transmitted the V2V information. The information transmission unit 114 transmits the information generated based on the V2V information transmitted by the mobile body 210A to the terminal apparatus 220A via the second wireless communication performed by the base station 150A. Further, the information transmission unit 114 transmits the information generated based on the V2V information transmitted by the mobile body 210A to the terminal apparatus 220B via the base station 150B. As in this example, in the present example embodiment, even when the communicable range of the V2V communication straddles the plurality of base stations 150, the information generated based on the V2V information transmitted by the mobile body 210 can be transmitted to the terminal apparatuses 220A and 220B located in the vicinity of the mobile body 210A via the Uu communication.

Note that the terminal apparatus 220 may request the MEC server 110 to transmit the second information and receive the second information as a response to the request. For example, when the V2V information is desirably received, the terminal apparatus 220 transmits a transmission request for the V2V information to the MEC server 110. The transmission request may include the communication address information of the terminal apparatus 220 and the position information of the terminal apparatus 220. As an example, with respect to the V2V information (acquired V2V information) received during a predetermined period (for example, one second, five seconds, ten seconds, or the like) before the time, the identification unit 113 of the MEC server 110 may compare the position information of the mobile body 210 that has transmitted the V2V information with the position information included in the transmission request, and identify the acquired V2V information to be sent to the terminal apparatus 220 that has transmitted the transmission request. This identification can be performed based on whether the position information of the terminal apparatus 220 is included in a predetermined range from the mobile body 210 that has transmitted the V2V information. The information transmission unit 114 may transmit the identified acquired V2V information to the terminal apparatus 220 by using the communication address information of the terminal apparatus 220, which is included in the transmission request. At this time, when there are a plurality of pieces of the identified acquired V2V information, each of the pieces of the acquired V2V information may be transmitted to the terminal apparatus 220 as a separate message or may be transmitted to the terminal apparatus 220 as a single message. As described above, when the communication address information and the position information of the terminal apparatus 220 are included in the transmission request, the position information management unit 112 does not need to manage the communication address information and the position information of the terminal apparatus 220. As another example, when the terminal apparatus 220 that has transmitted the transmission request is included in the terminal apparatus 220 identified in step A2, the information transmission unit 114 of the MEC server 110 may transmit the V2V information to the terminal apparatus 220 that has transmitted the transmission request. In this case, the information transmission unit 114 can know the communication address information of the terminal apparatus 220 by using the received transmission request. Therefore, it is not necessary for the position information management unit 112 to manage the communication address information of the terminal apparatus 220.

In the present example embodiment, the identification unit 113 identifies the terminal apparatus 220 located in the vicinity of the mobile body 210 that has transmitted the V2V information. The information transmission unit 114 transmits the information generated based on the received V2V information to the terminal apparatus 220 located in the vicinity of the mobile body 210 that has transmitted the identified V2V information. In this way, even in a case where the terminal apparatus 220 does not support the first wireless communication and cannot directly receive the V2V information from the mobile body 210 by using, for example, a PC5 direct communication, the terminal apparatus 220 can receive the information generated based on the V2V information from the MEC server 110 via the second wireless communication (for example, Uu communication) using the base station 150.

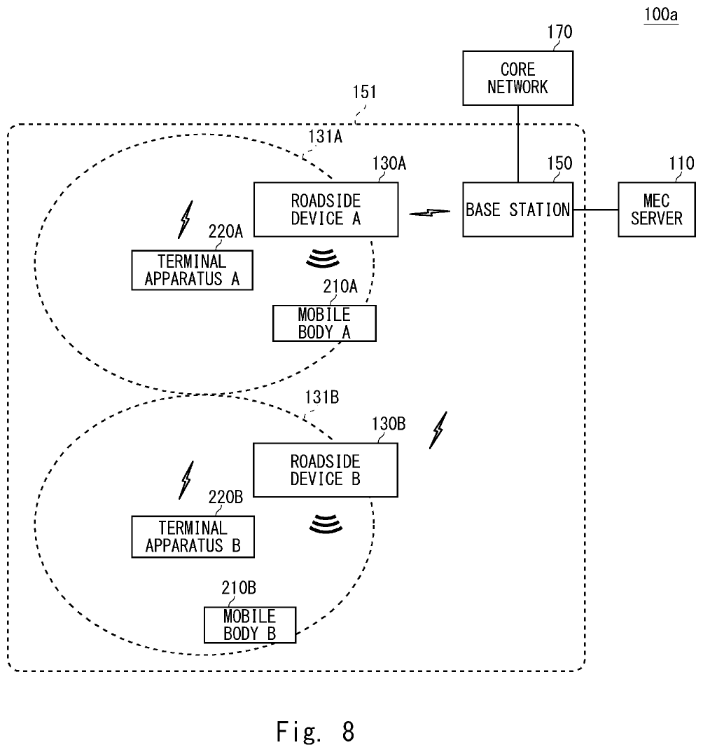

Next, a second example embodiment of the present disclosure will be explained. FIG. 8 illustrates a communication system according to the second example embodiment of the present disclosure. In the present example embodiment, a communication system 100a includes an MEC server 110, a roadside device 130A (roadside device A), a roadside device 130B (roadside device B), and a base station 150. The roadside devices 130A and 130B are associated to the roadside device 130 illustrated in FIG. 4. The present example embodiment is an example embodiment in which information transmitted from a terminal apparatus 220 is transmitted to a mobile body 210.

In the present example embodiment, a configuration of the MEC server 110 may be the same as the configuration of the MEC server 110 explained in the first example embodiment illustrated in FIG. 5. In the present example embodiment, the information reception unit 111 receives first information from the terminal apparatus 220 via a first wireless communication, for example, the Uu communication provided by the base station 150. The first information may be, for example, information of a mobile body including the terminal apparatus 220. Specifically, the first information may be V2V information or equivalent information when the mobile body is a vehicle, and Vehicle-to-Pedestrian (V2P) information or equivalent information when the mobile body is a person. The first information may include at least one piece of information of position information, speed information, acceleration information, mobile body attributes, and a time of the mobile body having the terminal apparatus 220. The mobile body attribute is information indicating a type of the mobile body, and includes, for example, information such as “automobile” and “pedestrian”.

The position information management unit 112 manages information of the roadside device 130. The information of the roadside device 130 includes position information of the roadside devices 130A and 130B. Further, the information of the roadside device 130 includes communication address information of the roadside device 130 used in a communication between the MEC server 110 and the roadside device 130. The identification unit 113 identifies the roadside device 130 located in the vicinity of the terminal apparatus 220 that has transmitted the first information, based on position information of the terminal apparatus 220 included in the first information transmitted from the terminal apparatus 220 and the information of the roadside device 130 to be managed by the position information management unit 112. Herein, “the vicinity of the terminal apparatus” means, for example, a range within a predetermined distance from the terminal apparatus 220.

The identification unit 113 identifies, for example, one or a plurality of roadside devices 130 existing within a predetermined range from the terminal apparatus 220 that has transmitted the first information as roadside devices located in the vicinity of the terminal apparatus 220. Herein, the predetermined range may be a range within a predetermined distance from the terminal apparatus 220, or may indicate a range in which the first information can be received (a communicable range of a V2V communication) when it is assumed that the terminal apparatus 220 transmits the information by using a second wireless communication (for example, PC5 direct communication). Further, the identification unit 113 may identify the roadside device 130 having the closest distance to the terminal apparatus 220 that has transmitted the first information as the roadside device 130 located in the vicinity of the terminal apparatus 220. A position of the terminal apparatus 220 that has transmitted the first information can be determined by using, for example, the position information included in the first information. Alternatively, as in the first example embodiment, the position information management unit 112 may manage the position information of the terminal apparatus 220. In this case, the identification unit 113 may acquire the position information of the terminal apparatus 220 that has transmitted the first information and the position information of the roadside device 130 from the position information management unit 112, and identify the roadside device located in the vicinity of the terminal apparatus 220.

The information transmission unit 114 transmits second information generated based on the first information to the roadside device 130 identified by the identification unit 113. In the present example embodiment, the second information may be the same information as the first information transmitted from the terminal apparatus 220, or may be information acquired by processing the first information in such a way as to be compatible with the processing in the mobile body 210. The roadside device 130 transmits the second information received from the information transmission unit 114 by using the second wireless communication, for example, a PC5 direct communication. The mobile body 210 existing within a communicable range of the second wireless communication by the roadside device 130 may receive the second information transmitted from the roadside device 130. The communication address information of the roadside device 130 identified by the identification unit 113 can be acquired from the position information management unit 112.

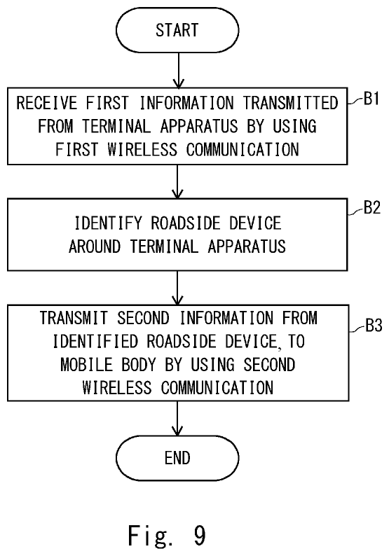

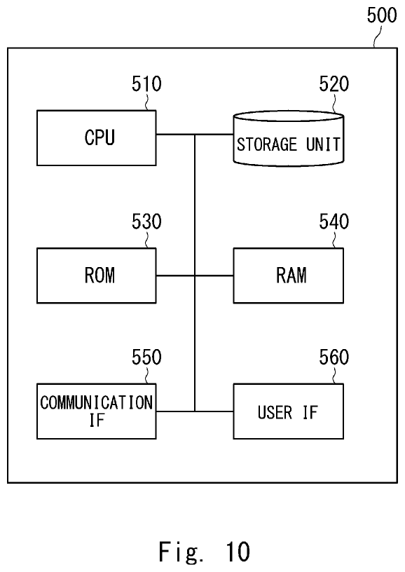

Next, an operation procedure in the present example embodiment will be explained. FIG. 9 illustrates an operation procedure of the MEC server 110. The information reception unit 111 receives, via the base station 150, the first information transmitted from the terminal apparatus 220 by using the first wireless communication, for example, a Uu communication (step B1). The identification unit 113 identifies the roadside device 130 located in the vicinity of the terminal apparatus 220 that has transmitted the first information, based on the information (position information) of the roadside device 130 to be managed by the position information management unit 112 (step B2). The information transmission unit 114 transmits the second information to the roadside device identified by the identification unit 113 (step B3). The roadside device 130 transmits the second information by using the second wireless communication, for example, a PC5 direct communication. The mobile body 210 existing within the communicable range of the second wireless communication by the roadside device 130 may receive the second information from the roadside device 130.

For example, in FIG. 8, it is assumed that the terminal apparatus 220A transmits information (first information) equivalent to V2V information by using the Uu communication. In this case, the information reception unit 111 of the MEC server 110 receives the V2V information transmitted from the terminal apparatus 220A via the base station 150. The identification unit 113 identifies the roadside device 130A as a roadside device located in the vicinity of the terminal apparatus 220A. The information transmission unit 114 transmits V2V information (second information) to the roadside device 130A. The roadside device 130A broadcasts the V2V information by using the PC5 direct communication. By doing so, the MEC server 110 can transmit the V2V information to the mobile body 210A existing surrounding the terminal apparatus 220A.

In FIG. 8, it is assumed that the terminal apparatus 220B transmits the first information by using the Uu communication. In this case, the information reception unit 111 of the MEC server 110 receives the first information transmitted from the terminal apparatus 220B via the base station 150. The identification unit 113 identifies the roadside device 130B as a roadside device located in the vicinity of the terminal apparatus 220B. The information transmission unit 114 transmits the second information to the roadside device 130B. The roadside device 130B broadcasts the second information by using the PC5 direct communication. By doing so, the MEC server 110 can transmit the second information to the mobile body 210B existing surrounding the terminal apparatus 220B.

In the present example embodiment, the identification unit 113 identifies the roadside device 130 located in the vicinity of the terminal apparatus 220 that has transmitted the first information by using the first wireless communication. The information transmission unit 114 transmits the second information (V2V information) generated based on the first information to the identified roadside device 130. The roadside device 130 broadcasts the second information by using a second wireless communication, such as a PC5 direct communication. Since the terminal apparatus 220 does not support the second wireless communication, it is not possible to directly exchange information with the mobile body 210 through the PC5 direct communication. Even in such a case, in the present example embodiment, the mobile body 210 located in the vicinity of the terminal apparatus 220 can receive information from the terminal apparatus 220 via the MEC server 110.

Next, a hardware configuration of the MEC server 110 will be explained. FIG. 10 illustrates a configuration example of a computer apparatus that can be used as the MEC server 110 or the like. A computer apparatus 500 includes a control unit (CPU: Central Processing Unit) 510, a storage unit 520, a Read Only Memory (ROM) 530, a Random Access Memory (RAM) 540, a communication interface (IF) 550, and a user interface 560.

The communication interface 550 is an interface for connecting the computer apparatus 500 and a communication network via a wired communication means, a wireless communication means, or the like. The user interface 560 includes a display unit such as a display, for example. The user interface 560 includes an input unit such as a keyboard, a mouse, and a touch panel.

The storage unit 520 is an auxiliary storage device capable of holding various types of data. The storage unit 520 is not necessarily a part of the computer apparatus 500, and may be an external storage device or a cloud storage connected to the computer apparatus 500 via a network.

The ROM 530 is a nonvolatile storage device. For example, a semiconductor memory device such as a flash memory having a relatively small capacity is used for the ROM 530. The program to be executed by the CPU 510 may be stored in the storage unit 520 or the ROM 530. The storage unit 520 or the ROM 530 stores various programs for achieving the functions of the units in the MEC server 110, for example.

The program can be stored by using various types of non-transitory computer-readable media and supplied to the computer apparatus 500. Non-transitory computer-readable media include tangible storage media of various types. Examples of the non-transitory computer-readable media include magnetic recording media, magneto-optical recording media, optical disk media, and semiconductor memory. The magnetic recording medium includes a recording medium such as a flexible disk, a magnetic tape, or a hard disk. The magneto-optical recording medium includes, for example, a recording medium such as a magneto-optical disk. The optical disc medium includes a disc medium such as CD (compact disc) or DVD (digital versatile disk). The semiconductor memory includes memory such as mask ROM, programmable ROM (PROM), erasable PROM (EPROM), flash ROM, or RAM. The program may also be supplied to a computer by using various types of transitory computer-readable media. Examples of the transitory computer-readable media include electrical signals, optical signals, and electromagnetic waves. The transitory computer readable medium can supply the program to the computer via a wired communication path such as an electric wire and an optical fiber, or a wireless communication path.

The RAM 540 is a volatile storage device. Various types of semiconductor memory devices such as Dynamic Random Access Memory (DRAM) or Static Random Access Memory (SRAM) are used for the RAM 540. The RAM 540 may be used as an internal buffer for temporarily storing data and the like. The CPU 510 loads a program stored in the storage unit 520 or the ROM 530 into the RAM 540 and executes the program. The CPU 510 executes the program, whereby the functions of the units in the MEC server 110 can be achieved. The CPU 510 may have an internal buffer capable of temporarily storing data and the like.

While the example embodiments of the present disclosure have been explained in detail above, the present disclosure is not limited to the above-described example embodiments, and changes and modifications applied to the above-described example embodiments without departing from the spirit of the present disclosure are also included in the present disclosure.

For example, some or all of the above-described example embodiments may be described as the following supplementary notes, but are not limited thereto.

### [Supplementary Note 1]

A server including:
a reception means for receiving, from a roadside device, first information transmitted from a mobile body by using a first wireless communication;
an information management means for managing information of a terminal apparatus having a function of performing a second wireless communication;
an identification means for identifying the terminal apparatus being located around the mobile body that has transmitted the first information, based on information of the terminal apparatus to be managed by the information management means; and
a transmission means for transmitting, to the terminal apparatus identified by the identification means, second information generated based on the first information, via the second wireless communication.

### [Supplementary Note 2]

The server according to supplementary note 1, wherein
the first wireless communication is a broadcast communication, and
the second wireless communication is a unicast communication.

### [Supplementary Note 3]

The server according to supplementary note 1 or 2, wherein the identification means identifies the terminal apparatus existing in a predetermined range from the mobile body as the terminal apparatus being located around the mobile body.

### [Supplementary Note 4]

The server according to any one of supplementary notes 1 to 3, wherein the information of the terminal apparatus includes position information of the terminal apparatus, and the identification means identifies the terminal apparatus being located around the mobile body, based on the position information.

### [Supplementary Note 5]

The server according to supplementary note 4, wherein
the information of the terminal apparatus further includes communication address information of the terminal apparatus, and
the transmission means transmits the second information to the identified terminal apparatus by using communication address information of the identified terminal apparatus.

### [Supplementary Note 6]

The server according to any one of supplementary notes 1 to 5, wherein, when a transmission request of the second information transmitted from the terminal apparatus is received, and when the terminal apparatus that has transmitted the transmission request is located around the mobile body that has transmitted the first information, the transmission means transmits the second information to the terminal apparatus that has transmitted the transmission request.

### [Supplementary Note 7]

The server according to any one of supplementary notes 1 to 6, wherein the transmission means transmits the second information to the identified terminal apparatus via a base station that performs a communication with the terminal apparatus by using the second wireless communication.

### [Supplementary Note 8]

The server according to any one of supplementary notes 1 to 7, wherein
the first information is Vehicle to Vehicle (V2V) information, and
the second information is information including at least a part of the V2V information.

### [Supplementary Note 9]

A server including:
a reception means for receiving first information from a terminal apparatus having a function of performing a first wireless communication, via the first wireless communication;
an information management means for managing information of a roadside device configured to communicate with a mobile body by using a second wireless communication;
an identification means for identifying, based on information of the roadside device to be managed by the information management means, the roadside device being located around the terminal apparatus that has transmitted the first information; and
a transmission means for transmitting second information generated based on the first information to the roadside device identified by the identification means, and causing the roadside device to transmit the second information to the mobile body by using the second wireless communication.

### [Supplementary Note 10]

The server according to supplementary note 9, wherein
the first wireless communication is a unicast communication, and
the second wireless communication is a broadcast communication.

### [Supplementary Note 11]

The server according to supplementary note 9 or 10, wherein the identification means identifies the roadside device existing in a predetermined range from the terminal apparatus as the roadside device being located around the terminal apparatus.

[Supplementary note 12]

The server according to any one of supplementary notes 9 to 11, wherein
the first information is Vehicle to Vehicle (V2V) information, and
the second information is information including at least a part of the V2V information.

### [Supplementary Note 13]

A communication system including a roadside device configured to communicate with a mobile body by using a first wireless communication, and a server, wherein
the roadside device includes:
a reception means for receiving first information transmitted from the mobile body by using the first wireless communication; and
a transmission means for transmitting the received first information to the server, and
the server includes:
a reception means for receiving the first information from the roadside device;
an information management means for managing information of a terminal apparatus having a function of performing a second wireless communication;
an identification means for identifying the terminal apparatus being located around the mobile body that has transmitted the first information, based on information of the terminal apparatus to be managed by the information management means; and
a transmission means for transmitting second information generated based on the first information to the terminal apparatus identified by the identification means via the second wireless communication.

### [Supplementary Note 14]

The communication system according to supplementary note 13, wherein
the first wireless communication is a broadcast communication, and
the second wireless communication is a unicast communication.

### [Supplementary Note 15]

The communication system according to supplementary note 13 or 14, wherein the identification means identifies the terminal apparatus existing in a predetermined range from the mobile body as the terminal apparatus being located around the mobile body.

### [Supplementary Note 16]

A communication system including:
a server configured to communicate with a terminal apparatus via a first wireless communication; and
a roadside device configured to communicate with a mobile body by using second wireless communication, wherein
the server includes:
a reception means for receiving first information from the terminal apparatus via the first wireless communication;
an information management means for managing information of the roadside device;
an identification means for identifying the roadside device being located around the terminal apparatus that has transmitted the first information, based on information of the roadside device to be managed by the information management means; and
a transmission means for transmitting second information generated based on the first information to the roadside device identified by the identification means, and
the roadside device includes:
a reception means for receiving the second information from the server; and
a transmission means for transmitting the received second information to the mobile body by using the second wireless communication.

### [Supplementary Note 17]

The communication system according to supplementary note 16, wherein
the first wireless communication is a unicast communication, and
the second wireless communication is a broadcast communication.

### [Supplementary Note 18]

The communication system according to supplementary note 16 or 17, wherein the identification means identifies the roadside device existing in a predetermined range from the terminal apparatus as the roadside device being located around the terminal apparatus.

### [Supplementary Note 19]

A communication method including:
receiving, from a roadside device, first information transmitted from a mobile body by using a first wireless communication;
identifying, based on information of a terminal apparatus having a function of performing a second wireless communication, the terminal apparatus being located around the mobile body that has transmitted the first information; and
transmitting, to the identified terminal apparatus, second information generated based on the first information via the second wireless communication.

### [Supplementary Note 20]

A communication method including:
receiving first information from a terminal apparatus having a function of performing a first wireless communication via the first wireless communication;
identifying, based on information of a roadside device configured to communicate with a mobile body by using a second wireless communication, the roadside device being located around the terminal apparatus that has transmitted the first information; and
transmitting second information generated based on the first information to the identified roadside device, and causing the roadside device to transmit the second information to the mobile body by using the second wireless communication.

### [Supplementary Note 21]

A non-transitory computer-readable medium storing a program for causing a computer to execute processing of:
receiving, from a roadside device, first information transmitted from a mobile body by using a first wireless communication;
identifying, based on information of a terminal apparatus having a function of performing a second wireless communication, the terminal apparatus being located around the mobile body that has transmitted the first information; and
transmitting, to the identified terminal apparatus, second information generated based on the first information via the second wireless communication.

### [Supplementary Note 22]

A non-transitory computer-readable medium storing a program for causing a computer to execute processing of:
receiving first information from a terminal apparatus having a function of performing a first wireless communication via the first wireless communication;
identifying, based on information of a roadside device configured to communicate with a mobile body by using a second wireless communication, the roadside device being located around the terminal apparatus that has transmitted the first information; and
transmitting second information generated based on the first information, to the identified roadside device, and causing the roadside device to transmit the second information to the mobile body by using the second wireless communication.

### REFERENCE SIGNS LIST

10 COMMUNICATION SYSTEM
20 SERVER
21 RECEPTION MEANS
22 INFORMATION MANAGEMENT MEANS
23 IDENTIFICATION MEANS
24 TRANSMISSION MEANS
30 MOBILE BODY
40 ROADSIDE DEVICE
41 RECEPTION MEANS
42 TRANSMISSION MEANS
50 TERMINAL APPARATUS
100 COMMUNICATION SYSTEM
110 MEC SERVER
111 INFORMATION RECEPTION UNIT
112 POSITION INFORMATION MANAGEMENT UNIT
113 IDENTIFICATION UNIT
114 INFORMATION TRANSMISSION UNIT
130 ROADSIDE DEVICE
131 COMMUNICABLE RANGE
150 BASE STATION
151 COMMUNICABLE RANGE
170 CORE NETWORK
210 MOBILE BODY
220 TERMINAL APPARATUS
500 COMPUTER APPARATUS
510 CPU
520 STORAGE UNIT
530 ROM
540 RAM
550 COMMUNICATION INTERFACE
560 USER INTERFACE

What is claimed is:

1. A server comprising:
a memory storing instructions; and
a processor configured to execute the instructions to
receive, from a roadside device, first information transmitted from a mobile body by using a first wireless communication;
manage information of a terminal apparatus having a function of performing a second wireless communication;
identify the terminal apparatus being located around the mobile body that has transmitted the first information, based on the managed information of the terminal apparatus; and
transmit, to the identified terminal apparatus, second information generated based on the first information, via the second wireless communication.

2. The server according to claim 1, wherein
the first wireless communication is a broadcast communication, and
the second wireless communication is a unicast communication.

3. The server according to claim 1, wherein the processor is configured to execute the instructions to identify the terminal apparatus existing in a predetermined range from the mobile body as the terminal apparatus being located around the mobile body.

4. The server according to claim 1, wherein
the information of the terminal apparatus includes position information of the terminal apparatus, and
the processor is configured to execute the instructions to identify the terminal apparatus being located around the mobile body, based on the position information.

5. The server according to claim 4, wherein
the information of the terminal apparatus further includes communication address information of the terminal apparatus, and
the processor is configured to execute the instructions to transmit the second information to the identified terminal apparatus by using communication address information of the identified terminal apparatus.

6. The server according to claim 1, wherein, when a transmission request of the second information transmitted from the terminal apparatus is received, and when the terminal apparatus that has transmitted the transmission request is located around the mobile body that has transmitted the first information, the processor is configured to execute the instructions to transmit the second information to the terminal apparatus that has transmitted the transmission request.

7. The server according to claim 1, wherein the processor is configured to execute the instructions to transmit the second information to the identified terminal apparatus via a base station that performs a communication with the terminal apparatus by using the second wireless communication.

8. The server according to claim 1, wherein
the first information is Vehicle to Vehicle (V2V) information, and
the second information is information including at least a part of the V2V information.

9. A server comprising:
a memory storing instructions; and
a processor configured to execute the instructions to:
receive first information from a terminal apparatus having a function of performing a first wireless communication, via the first wireless communication;
manage information of a roadside device configured to communicate with a mobile body by using a second wireless communication;
identify, based on the managed information of the roadside device, the roadside device being located around the terminal apparatus that has transmitted the first information; and
transmit second information generated based on the first information, to the identified roadside device, and causing the roadside device to transmit the second information to the mobile body by using the second wireless communication.

10. The server according to claim 9, wherein
the first wireless communication is a unicast communication, and
the second wireless communication is a broadcast communication.

11. The server according to claim 9, wherein the processor is configured to execute the instructions to identify the roadside device existing in a predetermined range from the terminal apparatus as the roadside device being located around the terminal apparatus.

12. The server according to claim 9, wherein
the first information is Vehicle to Vehicle (V2V) information, and
the second information is information including at least a part of the V2V information.

13. A communication system comprising:
a roadside device configured to communicate with a mobile body by using a first wireless communication; and the server according to claim 1, wherein
the roadside device is configured to:
receive first information transmitted from the mobile body by using the first wireless communication; and
transmit the received first information to the server.

14. The communication system according to claim 13, wherein
the first wireless communication is a broadcast communication, and
the second wireless communication is a unicast communication.

15. The communication system according to claim 13, wherein the processor is configured to execute the instructions to identify the terminal apparatus existing in a predetermined range from the mobile body as the terminal apparatus being located around the mobile body.

16. A communication system comprising:
the server according to claim 9; and
a roadside device configured to communicate with a mobile body by using a second wireless communication, wherein
the roadside device is configured to:
receive the second information from the server; and
transmit the received second information to the mobile body by using the second wireless communication.

17. The communication system according to claim 16, wherein
the first wireless communication is a unicast communication, and
the second wireless communication is a broadcast communication.

18. The communication system according to claim 16, wherein the processor is configured to execute the instructions to identify the roadside device existing in a predetermined range from the terminal apparatus as the roadside device being located around the terminal apparatus.

19. A communication method comprising:
receiving, from a roadside device, first information transmitted from a mobile body by using a first wireless communication;
identifying, based on information of a terminal apparatus having a function of performing a second wireless communication, the terminal apparatus being located around the mobile body that has transmitted the first information; and
transmitting, to the identified terminal apparatus, second information generated based on the first information via the second wireless communication.

20-22. (canceled)
